(19) United States
(12) Patent Application Publication
(10) Pub. No.: US 2024/0335981 A1
(43) Pub. Date: Oct. 10, 2024

(54) METHOD AND SYSTEM FOR RECYCLING WIND TURBINE BLADES

(71) Applicant: ReGen Fiber, LLC, Cedar Rapids, IA (US)

(72) Inventors: John Espeland, Des Moines, IA (US); Michael Olson, Ankeny, IA (US); Troy Wright, Johnston, IA (US)

(21) Appl. No.: 18/747,321

(22) Filed: Jun. 18, 2024

Related U.S. Application Data
(63) Continuation of application No. 17/512,233, filed on Oct. 27, 2021, now Pat. No. 12,053,908.
(60) Provisional application No. 63/144,128, filed on Feb. 1, 2021.

(51) Int. Cl. B29B 17/02; B02C 19/00; B02C 23/38; B29K 309/08; B29K 511/14; B29L 31/08

(52) U.S. Cl. CPC B29B 17/02; B02C 19/00; B02C 23/38; B29B 2017/0227; B29B 2017/0231; B29K 2309/08; B29K 2511/14; B29L 2031/085

(57) ABSTRACT

A method and system for recycling wind turbine blades. A scalper scalps off balsa wood and foam from recycled composite chips, a lump breaker shatters the chips produced by the scalper, a hammer mill breaks fiber chips produced by the lump breaker to reduce the chips to strand clusters, a vibratory screen and cyclone air classifier or circular vibratory screener separate strand clusters of acceptable size from larger strand clusters that require repeated processing with a hammer mill, another vibratory screen and cyclone air classifier or circular vibratory screener further separate strand clusters of acceptable size from larger strand clusters that require repeated processing with a hammer mill, and a granulator pulverizes the resulting fiber strand into micro-fibers that can be used as reinforcement fibers.

### CROSS-REFERENCE TO RELATED APPLICATION(S)

This patent application is a continuation of U.S. patent application Ser. No. 17/512,233, filed Oct. 27, 2021, which claims priority to U.S. Provisional Patent Application No. 63/144,128 filed on Feb. 1, 2021, each of which is incorporated herein in its entirety by reference.

### TECHNICAL FIELD

This disclosure relates generally to a method and system for recycling wind turbine blades, and in particular to a method and system for processing materials from wind turbine blades to produce reinforcement fibers of various lengths and milled reinforced micro-fibers.

### BACKGROUND

Electricity produced by wind turbines, commonly referred to as wind energy, is a promising alternative to electricity produced by fossil fuels. In 2019, wind energy produced approximately 300 billion kWh in the U.S., amounting to about 7.3% of total U.S. utility-scale electricity generation. As of January 2019, there were more than 58,000 wind turbines recorded in the U.S. Wind Turbine Database. Wind turbines typically have a useful life of about ten years.

Wind turbine blades are typically constructed from composite materials. They are primarily fiberglass, and often have an internal structure consisting largely of balsa wood and foam. Despite their promise as a clean energy source, their composite construction makes wind turbine blades difficult to recycle, and many wind turbine blades end up in landfills.

For the reasons stated above, and for other reasons which will become apparent to those skilled in the art upon reading and understanding the specification, there is a need in the art for a method and system for recycling wind turbine blades. Thus, it is a primary object of the disclosure to provide a method and system for recycling wind turbine blades to produce reinforcement fibers and composite fillers.

These and other objects, features, or advantages of the present disclosure will become apparent from the specification and claims.

### SUMMARY

The disclosure relates to a method and system for recycling wind turbine blades. In one arrangement, a scalper scalps off most of the balsa wood and foam from recycled composite chips, a lump breaker shatters the chips produced by the scalper, a hammer mill breaks fiber chips produced by the lump breaker to reduce the chips to strand clusters, a vibratory screen and cyclone air classifier or circular vibratory screener separate strand clusters of acceptable size from larger strand clusters that require repeated processing with a hammer mill, another vibratory screen and cyclone air classifier or circular vibratory screener further separate strand clusters of acceptable size from larger strand clusters that require repeated processing with a hammer mill, and a granulator pulverizes the resulting fiber strand into micro-fibers that can be used as reinforcement fibers of various lengths and milled reinforced micro-fibers. The terms powder and micro-fibers may be used interchangeably without departing from the scope of the disclosure.

### BRIEF DESCRIPTION OF THE DRAWINGS

FIG. 1 depicts a scalper for recycling wind turbine blades and scalped fiberglass chips according to one embodiment.

FIG. 2 depicts a lump breaker for recycling wind turbine blades according to one embodiment.

FIG. 3 depicts hammer mills for recycling wind turbine blades according to one embodiment.

FIG. 4 depicts classifiers for sorting fiber materials in a method for recycling wind turbine blades according to one embodiment.

FIG. 5a depicts a process chart for recycling wind turbine blades according to one embodiment.

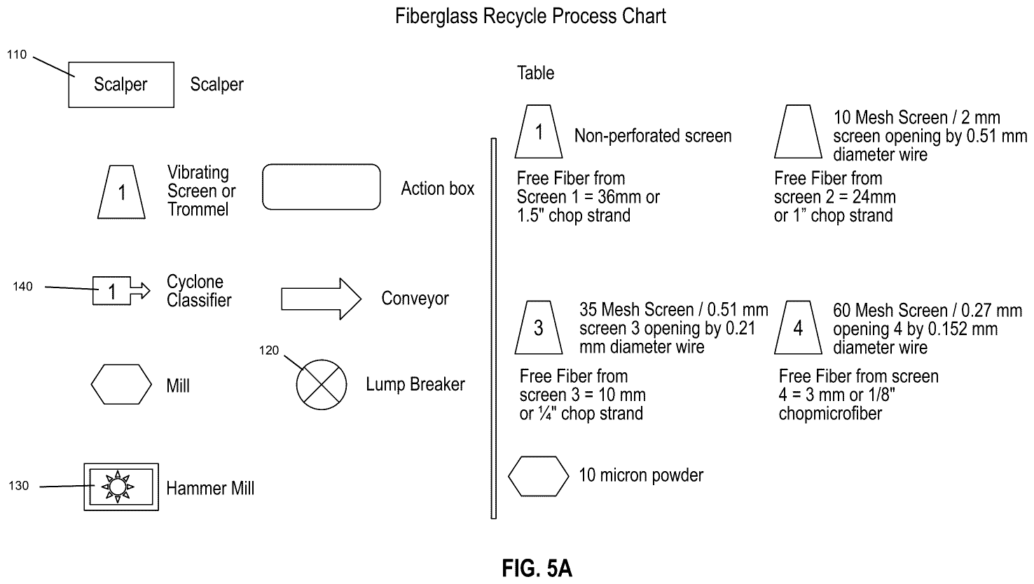

FIG. 5b depicts a process chart for recycling wind turbine blades according to one embodiment.

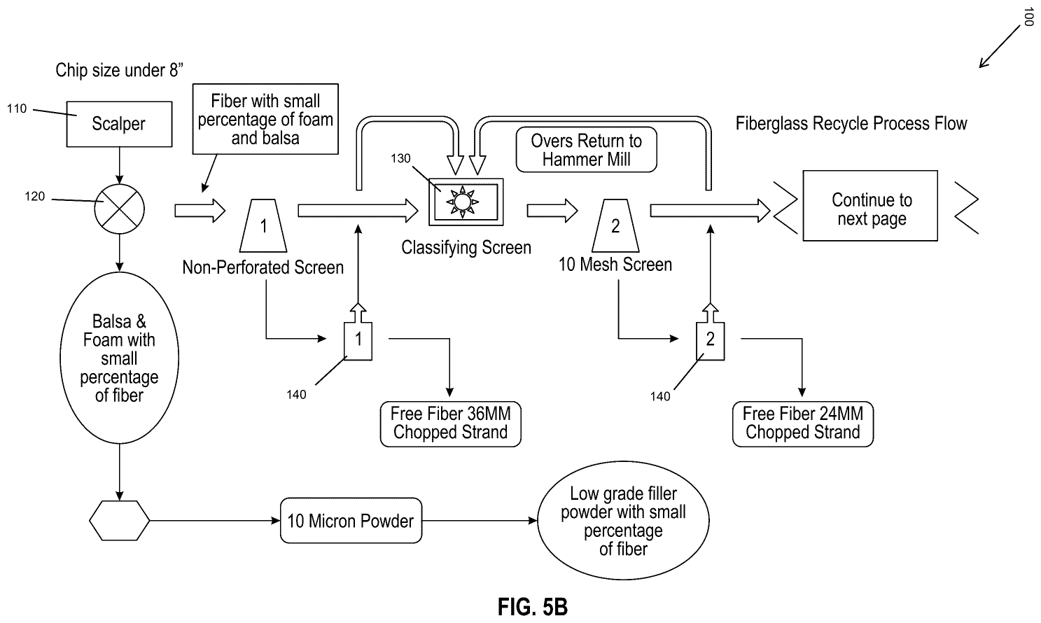

FIG. 5c depicts a process chart for recycling wind turbine blades according to one embodiment.

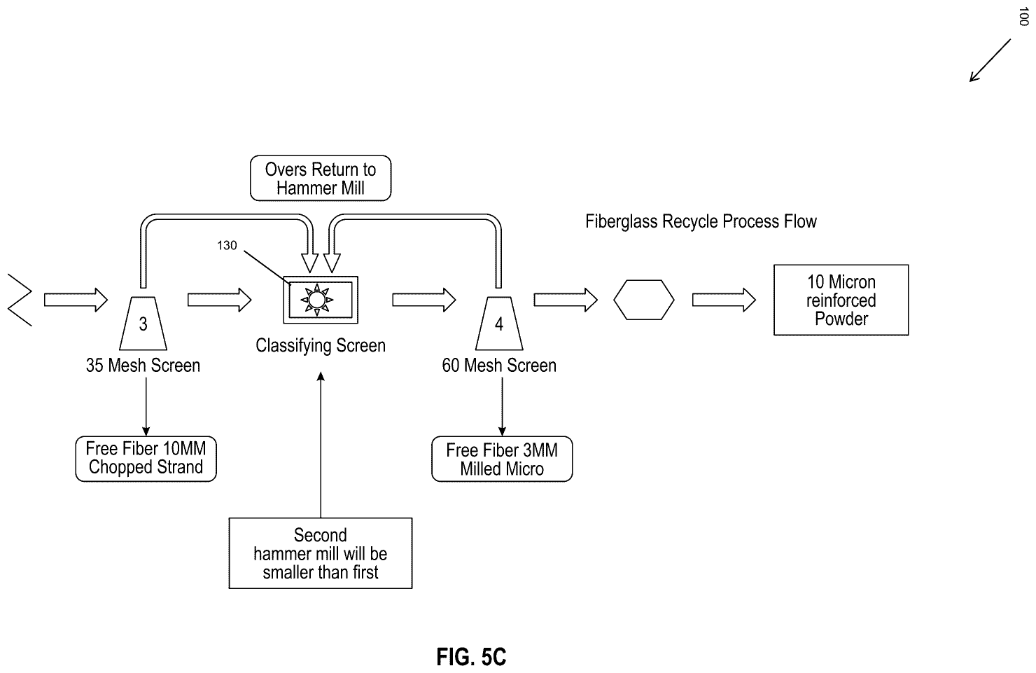

FIG. 6 depicts a method for recycling wind turbine blades according to one embodiment.

### DETAILED DESCRIPTION

In the following detailed description of the embodiments, reference is made to the accompanying drawings which form a part hereof, and in which is shown by way of illustration specific preferred embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the present disclosures. The following detailed description is, therefore, not to be taken in a limiting sense, and the scope of the present disclosure is defined only by the appended claims, along with the full scope of equivalents to which such claims are entitled.

As used herein, the terminology such as vertical, horizontal, top, bottom, front, back, end and sides are referenced according to the views presented. It should be understood, however, that the terms are used only for purposes of description, and are not intended to be used as limitations. Accordingly, orientation of an object or a combination of objects may change without departing from the scope of the disclosure.

### System for Recycling Wind Turbine Blades 100

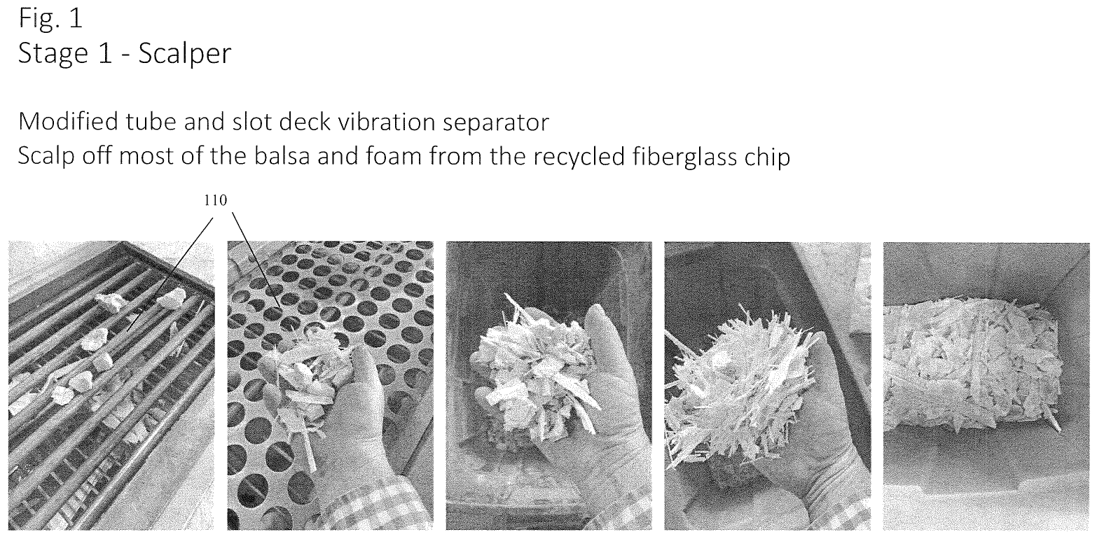

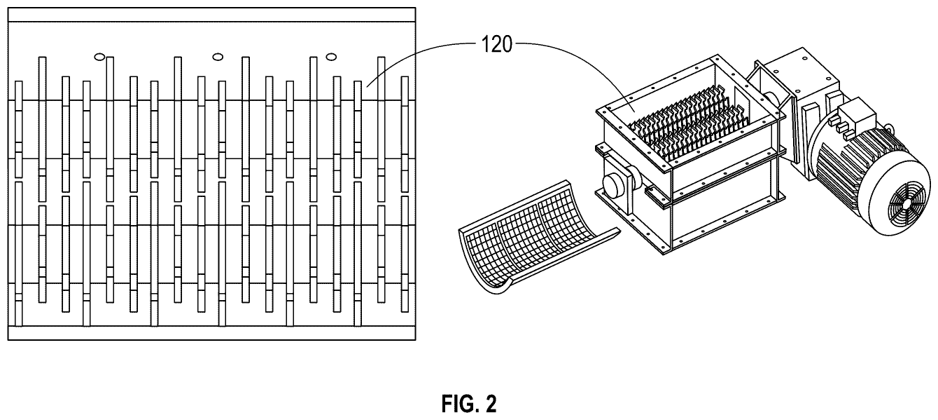

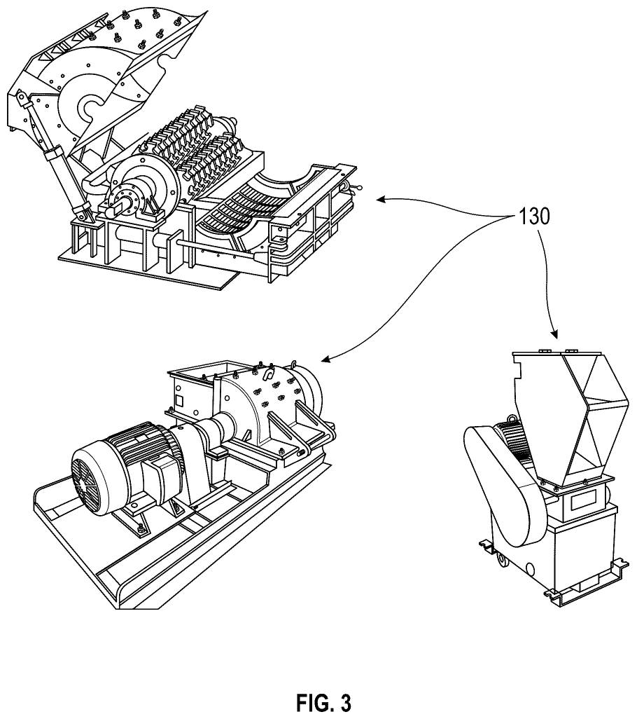

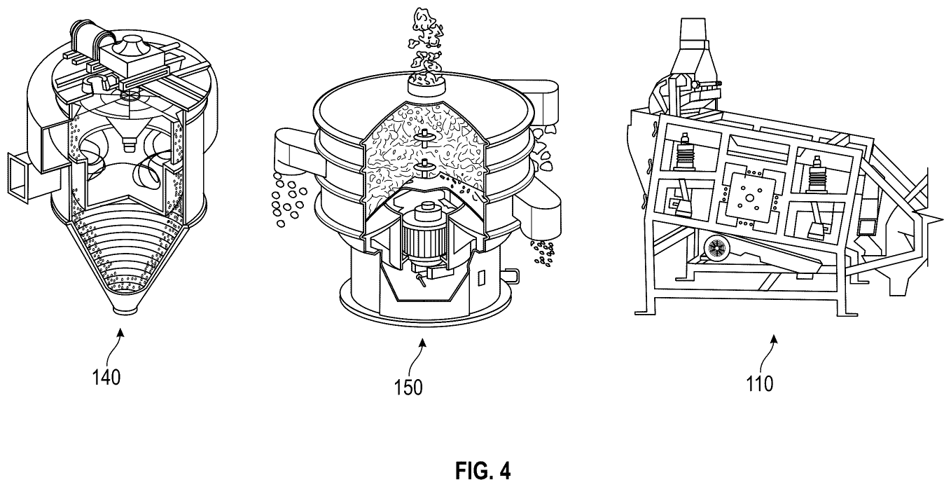

A system for recycling wind turbine blades 100 comprises a series of machines configured to process shredded chips ranging from 4″×4″ to 8″×8″ that may contain balsa wood, foam, or other materials used in wind turbine blade construction into fiberglass micro-fibers or fiber strand ⅛″ or finer that is suitable for use as a reinforcement fiber or composite filler. As shown in FIGS. 1-4, processing equipment used in system 100 may include one or more scalpers 110, one or more lump breakers 120, one or more hammer mills 130, and one or more cyclone classifiers 140 or vibratory screens 150.

### Scalper 110

System 100 may comprise one or more scalpers 110. Scalper 110 may comprise a modified tube and slot deck vibration separator. Scalper 110 scalps off most of the balsa and foam from the recycled fiberglass chip.

### Lump Breaker 120

System 100 may comprise one or more lump breakers 120. After being processed by scalper 110, chips may be conveyed from the scalper 110 to the lump breaker 120. Lump breaker 120 is configured to shatter chips into smaller sized chips to be processed by other components of system 100. In one embodiment, lump breaker 120 uses a screen size of at least 2 inch passing.

### Hammer Mill 130

System 100 may comprise one or more hammer mills 130. Hammer mill 130 is configured to break up all fiber chips into smaller sizes, and may be used to free fibers from the composite and reduce the chips to strand clusters.

### Vibratory Screen 150

A vibratory screen 150 may also be referred to as a circular vibratory screen 150, vibrating screen 150, or trommel 150. Vibratory screen 150 is configured to separate fibers of a particular size from larger pieces. Vibratory screen 150 may be equipped with screens of various sizes to separate different sizes of fibers. Vibratory screen 150 may be equipped with a non-perforated screen in which free fiber from the screen is 36 mm or 1.5 inch chop strand or smaller. Vibratory screen 150 may be equipped with a 10 mesh screen having 2 mm screen openings and 0.51 mm diameter wire and in which free fiber from the screen is 24 mm or 1 inch chop strand or smaller. Vibratory screen 150 may be equipped with a 35 mesh screen having 0.51 mm screen openings and 0.21 mm diameter wire and in which free fiber from the screen is 10 mm or ¼ inch chop strand or smaller. Vibratory screen 150 may be equipped with a 60 mesh screen having 0.27 mm screen openings and 0.152 mm diameter wire and in which free fiber from the screen is 3 mm or ⅛ inch chop strand or smaller.

### Method for Recycling Wind Turbine Blades 200

A method 200 for recycling or upcycling wind turbine blades is presented. The method 200 comprises multiple stages in which materials taken from wind turbine blades are processed into progressively finer materials. The materials produced by each stage of the method 200 each have a use in the composite industry or in the non-composite industry. After any stage of method 200, the materials produced in that stage may be extracted and used, or the materials produced in that stage may proceed to the next stage of the method 200.

### First Stage 210 of a Method for Recycling Wind Turbine Blades 200

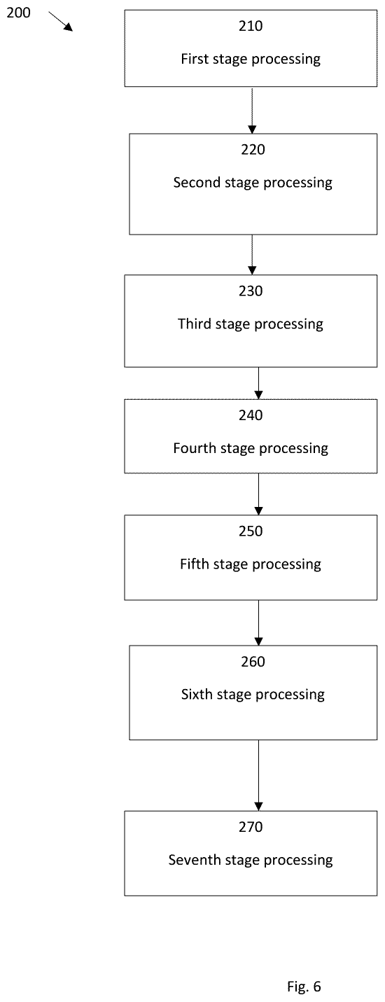

As shown in FIG. 6, a method for recycling wind turbine blades 200 begins at step 210. In a first stage 210 of a method for recycling wind turbine blades 200, shredded fiberglass chips ranging in size from 4×4 inches to 8×8 inches are inserted into scalper 110, which removes most of the balsa wood, foam, and other non-fiberglass materials from the input chips. Balsa wood and foam with trace amounts of fiber that have been scalped off by scalper 110 may be run through a granulator or mill that pulverizes the balsa wood and foam into 10-micron composite micro-fibers that may be used as low grade filler micro-fibers. After processing with scalper 110, the processed chips with trace amounts of balsa wood and foam may be extracted and used or may be conveyed to a lump breaker 120 for processing in a second stage 220 of a method for recycling wind turbine blades 200.

### Second Stage 220 of a Method for Recycling Wind Turbine Blades 200

In a second stage 220 of a method for recycling wind turbine blades 200, processed chips resulting from the first stage 210 are conveyed from the scalper 110 to a lump breaker 120. Lump breaker 120 shatters the chips resulting from the first stage 210 and shatters them into 2×2 inch chips. The resulting shattered 2×2 inch chips are run through a non-perforated vibratory screen configured to separate chips that are larger than 2×2 inches and chips that are smaller than 2×2 inches in size. Chips that are smaller than 2×2 inches are routed to a cyclone air classifier 140, which may alternatively be referred to as a cyclone classifier 140, or a circular vibratory screener 150 configured to separate fiber strands that are 1.5 inches (36 mm) or less from larger chips that are conveyed to hammer mill 130 for processing in a third stage 230 of a method for recycling wind turbine blades 200. After undergoing the second stage 220, the second stage chips may be extracted and used or may be conveyed to the third stage 230.

### Third Stage 230 of a Method for Recycling Wind Turbine Blades 200

In a third stage 230 of a method for recycling wind turbine blades 200, the larger chips classified by the cyclone classifier 140 or circular vibratory screener 150 during the second stage 220 are conveyed to a hammer mill 130 configured to break up all fiber chips into smaller sizes; thus freeing fibers from the composite and reducing the chips to strand clusters. After undergoing the third stage 230, the third stage chips may be extracted and used or may be conveyed to the fourth stage 240.

### Fourth Stage 240 of a Method for Recycling Wind Turbine Blades 200

In a fourth stage 240 of a method for recycling wind turbine blades 200, fiber strand clusters resulting from third stage 230 processing are conveyed to a vibratory screen and then processed through a cyclone air classifier 140 or a circular vibratory screener 150 equipped with a 10 mesh screen configured to separate chop strands that are 1 inch (24 mm) or less from larger pieces that are returned to hammer mill 130 for further processing. All chop strands or fine fiber clusters that are 1 inch or less may be extracted and used or may be conveyed to the fifth stage 250.

### Fifth Stage 250 of a Method for Recycling Wind Turbine Blades 200

In a fifth stage 250 of a method for recycling wind turbine blades 200, fine fiber clusters 1 inch or less in size separated out in the fourth stage 240 are conveyed to a vibratory screen and then processed through a cyclone air classifier 140 or a circular vibratory screener 150 equipped with a 35 mesh screen and configured to separate chop strands that are ¼ inch (10 mm) or less from larger pieces that are returned to hammer mill 130 with specific screens for reducing the balance of fiber materials to % inch to ⅛ inch fiber. The hammer mill 130 used at this stage of processing will be smaller than the hammer mill 130 used in earlier stages of processing. After undergoing the fifth stage 250, the fifth stage chips may be extracted and used or may be conveyed to the sixth stage 260.

### Sixth Stage 260 of a Method for Recycling Wind Turbine Blades 200

In a sixth stage 260 of a method for recycling wind turbine blades 200, fine fiber clusters ¼ inch or less in size separated out in the fifth stage 250 are conveyed to a vibratory screen and then processed through a cyclone air classifier 140 or a circular vibratory screener 150 equipped with a 60 mesh screen and configured to separate chop strands that are ⅛ inch (3 mm) or less (which are referred to as milled glass) from larger pieces that are returned to hammer mill 130 with specific screens for reducing the balance of fiber materials to % inch to ⅛ inch fiber. After undergoing the sixth stage 260, the sixth stage chips may be extracted and used or may be conveyed to the seventh stage 270.

### Seventh Stage 270 of a Method for Recycling Wind Turbine Blades 200

In a seventh stage 270 of a method for recycling wind turbine blades 200, all micro-fibers or fiber strand that is ⅛ inch in size or smaller is run through a granulator or mill to pulverize the fine fiber strand into micro-fibers. In one embodiment, the resulting micro-fibers comprise 10 micron reinforced micro-fibers.

Through implementation of method 200, reinforcement fiber of various lengths and milled reinforced micro-fibers are produced. In one embodiment, reinforcement fibers may range in length from 1/16 inch to 3 inches; however, other lengths of reinforcement fibers may also be produced without departing from the scope of the invention.

The system 100 and method 200 has many benefits and advantages including, but not limited to reducing the number of wind turbine blades placed in landfills and providing reinforcement fiber and milled reinforced micro-fibers alternatives that do not require new materials. These and other benefits and advantages of the system 100 and method 200 are apparent from the specification and claims.

### REFERENCE NUMERALS

100—system for recycling wind turbine blades
110—scalper
120—lump breaker
130—hammer mill
140—cyclone air classifier or cyclone classifier
150—vibratory screen or vibrating screen or circular vibratory screen or trommel
200—a method for recycling wind turbine blades
210—first stage a method for recycling wind turbine blades 200
220—second stage of a method for recycling wind turbine blades 200
230—third stage of a method for recycling wind turbine blades 200
240—fourth stage of a method for recycling wind turbine blades 200
250—fifth stage of a method for recycling wind turbine blades 200
260—sixth stage of a method for recycling wind turbine blades 200
270—seventh stage of a method for recycling wind turbine blades 200

We claim:

1. A method for recycling wind turbine blades, the method comprising:
(a) receiving at least portions of wind turbine blades, wherein the at least portions of wind turbine blades comprise chips of material, wherein the chips comprise wood, foam, and composite material;
(b) in a first stage, removing the composite material from the chips to form first composite pieces; and
(c) in one or more additional stages, repeatedly breaking the composite pieces into smaller composite pieces and separating larger pieces from smaller pieces.

2. The method of claim 1, wherein the one or more additional stages comprises a second stage, a third stage, a fourth stage, a fifth stage, a sixth stage, and a seventh stage, wherein the repeatedly breaking the composite pieces into smaller composite pieces and separating larger pieces from smaller pieces comprises:
(a) in the second stage, shattering the first composite pieces into second composite pieces that are smaller than the first composite pieces;
(b) in the second stage, separating the second composite pieces into a first subset of second composite pieces and a second subset of second composite pieces, wherein the first subset of second composite pieces comprises pieces larger than a first specified size and the second subset of second composite pieces comprises pieces that are smaller than the first specified size;
(c) in the third stage, breaking the first subset of second composite pieces into fiber strand clusters;
(d) in the fourth stage, separating the fiber strand clusters into a first subset of fiber strand clusters and a second subset of fiber strand clusters, wherein the first subset of fiber strand clusters comprises fiber strand clusters that are larger than a second specified size and the second subset of fiber strand clusters comprises fiber strand clusters that are smaller than the second specified size, and wherein the second subset of fiber strand clusters comprise chop strands;
(e) in the fifth stage, separating the chop strands into a first subset of chop strands and a second subset of chop strands, wherein the first subset of chop strands comprises chop strands that are larger than a third specified size and the second subset of chop strands comprises chop strands that are smaller than the third specified size;
(f) in the sixth stage, separating the second subset of chop strands into a first group of fiber clusters and a second group of fiber clusters, wherein the second group of fiber clusters comprises fiber clusters that are smaller than a fourth specified size, and wherein the first group of fiber clusters comprises fiber clusters that are larger than the fourth specified size; and
(g) in the seventh stage, pulverizing the second group of fiber clusters into micro-fibers or powder.

3. The method of claim 2, wherein breaking the first subset of second composite pieces into the fiber strand clusters comprises breaking the first subset of second composite pieces with a hammer mill.

4. The method of claim 2, wherein separating the fiber strand clusters into a first subset of fiber strand clusters and a second subset of fiber strand clusters comprises separating the fiber strand clusters using a vibratory screen and a cyclone air classifier, or using a circular vibratory screener.

5. The method of claim 2, wherein separating the chop strands into a first subset of chop strands and a second subset of chop strands comprises separating the chop strands using a vibratory screen and a cyclone air classifier, or using a circular vibratory screener.

6. The method of claim 2, wherein separating the second subset of chop strands into a first group of fiber clusters and a second group of fiber clusters comprises separating the second subset of chop strands using a vibratory screen and a cyclone air classifier, or using a circular vibratory screener.

7. The method of claim 2, wherein pulverizing the second group of fiber clusters comprises using a granulator or mill.

8. The method of claim 2, wherein:
the first specified size is two inches by two inches;
the second specified size is one inch by one inch;
the third specified size is one fourth of an inch by one fourth of an inch; and
the fourth specified size is one eighth of an inch by one eight of an inch.

9. The method of claim 1, wherein the chips of composite material are sized between four inches and eight inches at their largest dimensions.

10. The method of claim 1, wherein removing the composite material from the chips comprises separating the composite material from other material in the chips, and wherein the other material in the chips are further processed into fibrous filler material.

11. A system for recycling wind turbine blades, the system comprising:
a scalper configured to separate first portions of composite material from non-composite materials;
a lump breaker configured to break the first portions of composite material into second portions that are smaller than the first portions;
a hammer mill configured to break the second portions into strand clusters;
one or more screener systems configured to separate the strand clusters into first strand clusters and second strand clusters, wherein the first strand clusters are smaller than the second strand clusters; and
a granulator configured to pulverize the first strand clusters into micro-fibers or powder.

12. The system of claim 11, wherein:
(a) the lump breaker is configured to break the second strand clusters into third strand clusters that are smaller than the second strand clusters; or
(b) the system further comprises an additional lump breaker configured to break the second strand clusters into third strand clusters that are smaller than the second strand clusters.

13. The system of claim 11, wherein every surface of the first portions of composite material is smaller than eight square inches.

14. The system of claim 11, further comprising:
a first conveyor positioned to carry the first portions of composite material to the lump breaker; and
a second conveyor positioned to carry the first strand clusters or the second strand clusters from the one or more screener systems.

15. The system of claim 11, wherein the scalper comprises a tube and slot deck vibration separator.

16. The system of claim 11, wherein the lump breaker comprises a screen having openings at least 2 inches in any dimension.

17. The system of claim 11, wherein the one or more screener systems comprises at least one of a circulatory vibratory screener, a vibratory screener a cyclone air classifier, or a trommel.

18. The system of claim 17, wherein the one or more screener systems comprises one or more of: a non-perforated screen; a mesh screen formed with 0.51 millimeter diameter wire and having openings 2 millimeters across; a mesh screen formed with 0.21 millimeter diameter wire and having openings 0.51 millimeters across; or a mesh screen formed with 0.152 millimeter diameter wire and having openings 0.27 millimeters across.
